(19) United States
(12) Patent Application Publication
(10) Pub. No.: US 2007/0220741 A1
(43) Pub. Date: Sep. 27, 2007

(54) CABELESS INTERCONNECT SYSTEM FOR PICK AND PLACE MACHINE

(75) Inventors: Koenraad Gieskes, Binghamton, NY (US); Stanislaw Janisiewicz, Endwell, NY (US); Craig Fahrenkrug, Apalachin, NY (US); Darrin Weiss, Vestal, NY (US)

Correspondence Address: SCHMEISER, OLSEN & WATTS, 22 CENTURY HILL DRIVE, SUITE 302, LATHAM, NY, 12110, US

(73) Assignee: UI Holding Co., Conklin, NY (US)

(21) Appl. No.: 10/271,760

(22) Filed: Oct. 17, 2002

(51) Int. Cl. B23P 19/00

(52) U.S. Cl. 29/739; 29/740

(57) ABSTRACT

A pick and place head for a pick and place machine includes a stationary frame; a first circuit board mounted on the stationary frame, the first circuit board including a first plurality of electric circuits; a rotating frame rotatably mounted to the stationary frame; a plurality of spindle assemblies mounted one the rotating frame, each of the plurality of spindle assemblies including a set of electric contacts; a second circuit board mounted on the rotating frame, the second circuit board including a second plurality of electric circuits; a slip ring assembly mounted between the first circuit board and the second circuit board; the slip ring assembly including a first portion and a second portion; the first portion of the slip ring assembly being rotatable relative to the second portion of the slip ring assembly, and the slip ring assembly further including a set of electrical connectors that enable the first plurality of electric circuits to maintain electrical connection with the second plurality of electric circuits while the first portion rotates relative to the second portion; the second circuit board further including a plurality of electric contacts, the plurality of electric contacts on the second circuit board engaged with respective ones of the contacts of the plurality of spindle assemblies; an electric bus connected to the first plurality of circuits so as to provide power and control signals to the pick and place head; and a motor to rotate the second circuit board.

### BACKGROUND OF THE INVENTION

1. Field of the Invention

The present invention relates to a pick and place head for a pick and place machine, and more particularly for a cableless interconnect system for connecting circuits within the pick and place head.

2. Description of Related Art

The present invention relates primarily, although not exclusively, to machines known in the electronics assembly industry as pick and place machines. In a pick and place machine, a spindle mounted on a spindle assembly is brought into contact with a die: or other electronic component in order to pick up the component. The spindle assembly is; then moved to another location, wherein the die or component picked up by the spindle is then placed in an appropriate location for assembly. In order to minimize assembly time, it has been known to arrange a plurality of spindle assemblies on a pick and place head.

Each of the spindle assemblies typically includes a theta correction motor for correcting theta orientation of the spindle, and one or more air valves for applying a vacuum pressure or an air kiss to the end of the spindle.

Conventionally, control of the pick and place head, and the individual spindle assemblies, was enabled through a plurality of circuits, which were interconnected by cables. However, such systems were cumbersome in that the large number of cables and wires required were difficult to assemble and space consuming.

### OBJECTS AND SUMMARY

Accordingly, it is an object of the present invention to provide a pick and place head comprising a plurality of spindle assemblies, wherein a cableless system is provided to interconnect the various circuits within the pick and place head.

It is a further object of the present invention to provide a pick and place head having a rotating spindle support on which a plurality of spindle assemblies are mounted, wherein the spindle assemblies make electric contact with the rotating spindle support through a plurality of contact pads.

It is yet another object of the present invention to provide a pick and place head that includes a rotating support for a plurality of spindle assemblies, and wherein a slip ring assembly is used to interconnect the electric circuits of the spindle assemblies with those of a stationary circuit board on the mainframe of the pick and place head.

According to one aspect of the present invention, a pick and place head for a pick and place machine comprises a stationary frame; a first circuit board mounted on the stationary frame, the first circuit board including a first plurality of circuits and a first plurality of electric contacts connected to the first plurality of circuits; a rotating frame rotatably mounted to the stationary frame; a plurality of spindle assemblies mounted on the rotating frame; a second circuit board mounted on the rotating frame, the second circuit board including a second plurality of circuits relating to an operation of the plurality of spindle assemblies, and a second plurality of electric contacts connected to the second plurality of circuits; a slip ring assembly mounted between the first circuit board and the second circuit board; the slip ring assembly including a first portion having a third plurality of electric contacts and a second portion having a fourth plurality of electric contacts; the first portion of the slip ring assembly being rotatable relative to the second portion of the slip ring assembly, and the slip ring assembly further including a set of electrical connectors that enable the third plurality of electric contacts to maintain electrical connection with the fourth plurality of electric contacts while the first portion rotates relative to the second portion; the first portion being fixed relative to the first circuit board so that the third plurality of electric contacts are in electrical connection with the first plurality of electric contacts and the second portion being fixed relative to the second circuit board so that the fourth plurality of electric contacts are in electrical connection with the second plurality of electric contacts; the second circuit board further including a fifth plurality of electric contacts, the fifth plurality of electric contacts engaged with respective contacts of the plurality of spindl_assemblies; a bus connector connected to the first plurality of circuits so as to provide power and control signals to the pick and place head; and a motor to rotate the rotating frame.

According to another aspect of the present invention, a pick and place head for a pick and place machine comprises a stationary frame; a first circuit board mounted on the stationary frame, the first circuit board including a first plurality of electric circuits; a rotating frame rotatably mounted to the stationary frame; a plurality of spindle assemblies mounted on the rotating frame, each of the plurality of spindle assemblies including a set of electric contacts; a second circuit board mounted on the rotating frame, the second circuit board including a second plurality of electric circuits; a slip ring assembly mounted between the first circuit board and the second circuit board; the slip ring assembly including a first portion and a second portion; the first portion of the slip ring assembly being rotatable relative to the second portion of the slip ring assembly, and the slip ring assembly further including a set of electrical connectors that enable the first plurality of electric circuits to maintain electrical connection with the second plurality of electric circuits while the first portion rotates relative to the second portion; the second circuit board further including a plurality of electric contacts, the plurality of electric contacts on the second circuit board engaged with respective ones of the contacts of the plurality of spindle assemblies; a connector connected to the first plurality of circuits so as to provide power and control signals to the pick and place head; and a motor to rotate the rotating frame.

According to yet another aspect of the present invention, a pick and place head for a pick and place machine comprises a stationary frame; a first circuit board mounted on the stationary frame, the first circuit board including a first plurality of electric circuits; a rotating frame rotatably mounted to the stationary frame; a plurality of spindle assemblies mounted one the rotating frame, each of the plurality of spindle assemblies including a set of electric contacts; a second circuit board mounted on the rotating frame, the second circuit board including a second plurality of electric circuits; cableless means arranged between the first circuit board and the second circuit board for providing an electric connection between the first plurality of circuits and the second plurality of circuits while the rotating frame rotates relative to the stationary frame; the second circuit board further including a plurality of electric contacts, the plurality of electric contacts on the second circuit board engaged with respective ones of the contacts of the plurality of spindle assemblies; a connector connected to the first plurality of circuits so as to provide power and control signals to the pick and place head; and a motor to rotate the rotating frame.

### BRIEF DESCRIPTION OF THE DRAWINGS

FIG. 1 is a perspective view of a preferred embodiment of a pick and place head according to the present invention, wherein a portion of the pick and place head has been cut away to better illustrate the present invention.

FIG. 2 is a side view of certain components of a pick and place head according to preferred embodiments of the present invention, wherein some components are omitted to better illustrate the present invention.

FIG. 3 is a perspective view of some of the components included on a pick and place head according to preferred embodiments of the present invention, wherein some components are omitted to enhance the understanding thereof.

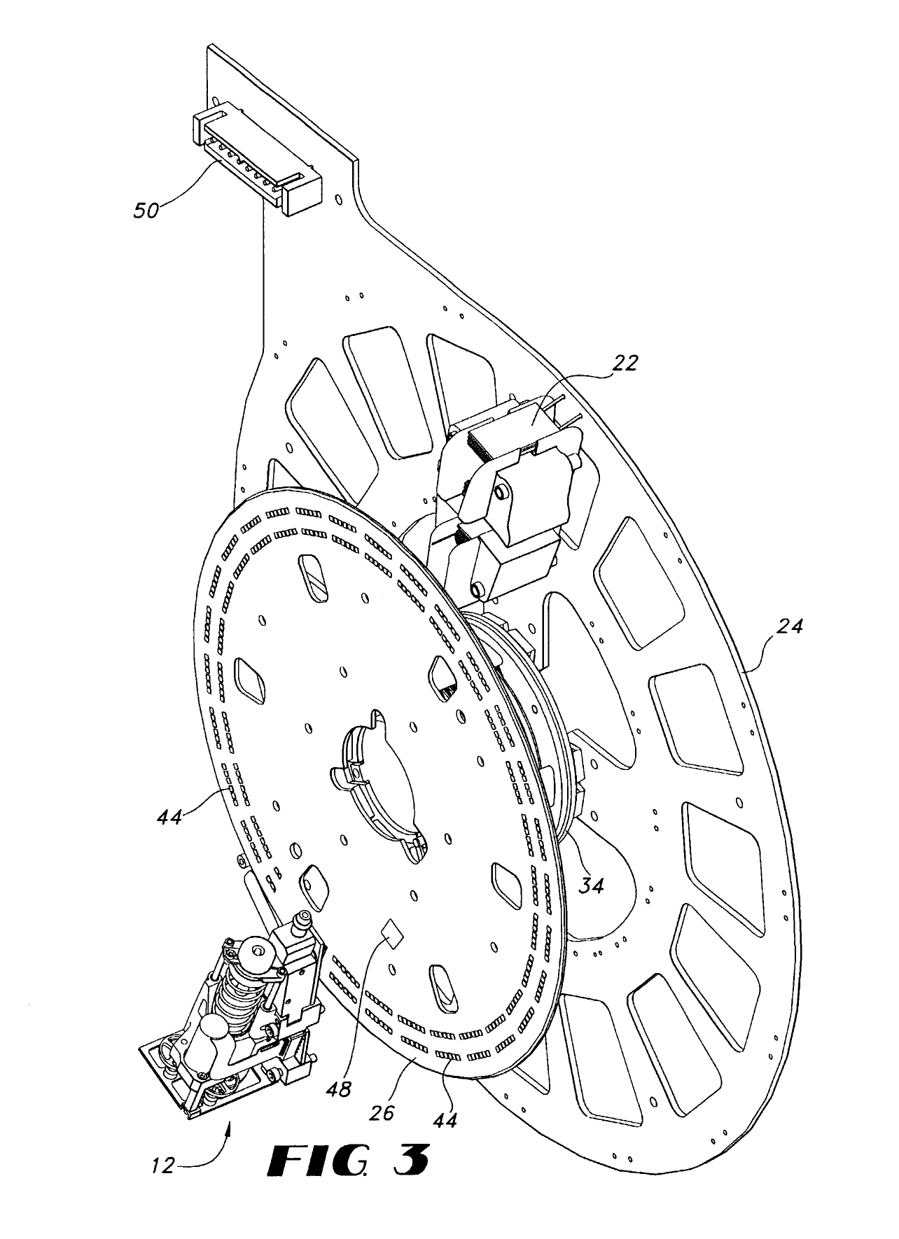

### DETAILED DESCRIPTION OF THE PREFERRED EMBODIMENTS

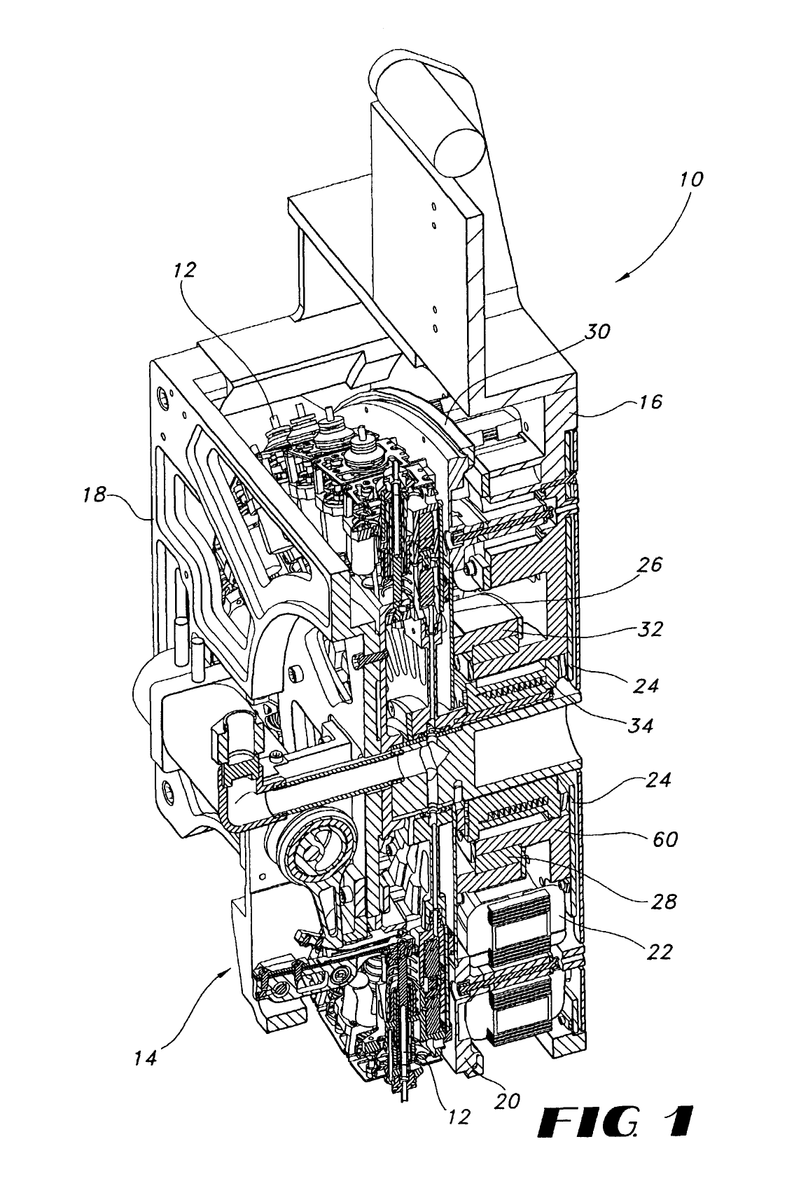

FIG. 1 is a perspective view of a pick and place head 10 according to a preferred embodiment of the present invention.

The pick and place head 10 includes a front frame 18 and a rear frame 16. Bearings 28 mounted on the rear frame 16 support a rotating spindle support or frame 20, on which are mounted a plurality of individual spindle assemblies 12. A collar 32 projects from the rotating spindle frame 20 and engages the bearing 28 in order to provide rotatable support for the rotating spindle frame 20.

A motor 22, only a portion of which can be seen in FIG. 1, is mounted circumferentially around the rotating spindle frame 20 for driving the rotating spindle frame 20.

An encoder 30 is mounted on the rotating spindle frame 20 to provide a signal indicative of the position of the rotating spindle frame 20.

A spindle driving assembly 14 is mounted to the front frame 18 for actuating whichever spindle assembly is located in the actuating position of the pick and place head 10. In the preferred exemplary embodiment of the present invention, the actuating position is at the bottom of the pick and place head 10, so that the spindle assembly 12 at the lowermost position on the rotating spindle frame 20 can be actuated by the spindle driving assembly 14. The aforementioned copending patent applications filed on even date herewith disclose greater details of the spindle driving assembly 14.

Mounted to a rear side of the rear frame 16 of the pick and place head 10 is a stationary circuit board 24, which includes a plurality of circuits thereon, together with a bus connector 52 for connection to a control system for the pick and place machine. The stationary circuit board 24 also includes a motor connector 50 that is interconnected to the circuits on the stationary circuit board 24. The motor connector 50 is used to control actuation of the motor 22 for driving the rotating spindle frame 20.

In the preferred embodiment, the bus connector 52 is a CAN Bus Device Net type interface which enables the elimination of parallel connections used to control the various features of the pick and place head. Such a connection greatly reduces the number of cables needed to control all of the spindle assemblies. However, in alternative embodiments, other connecting devices may be used.

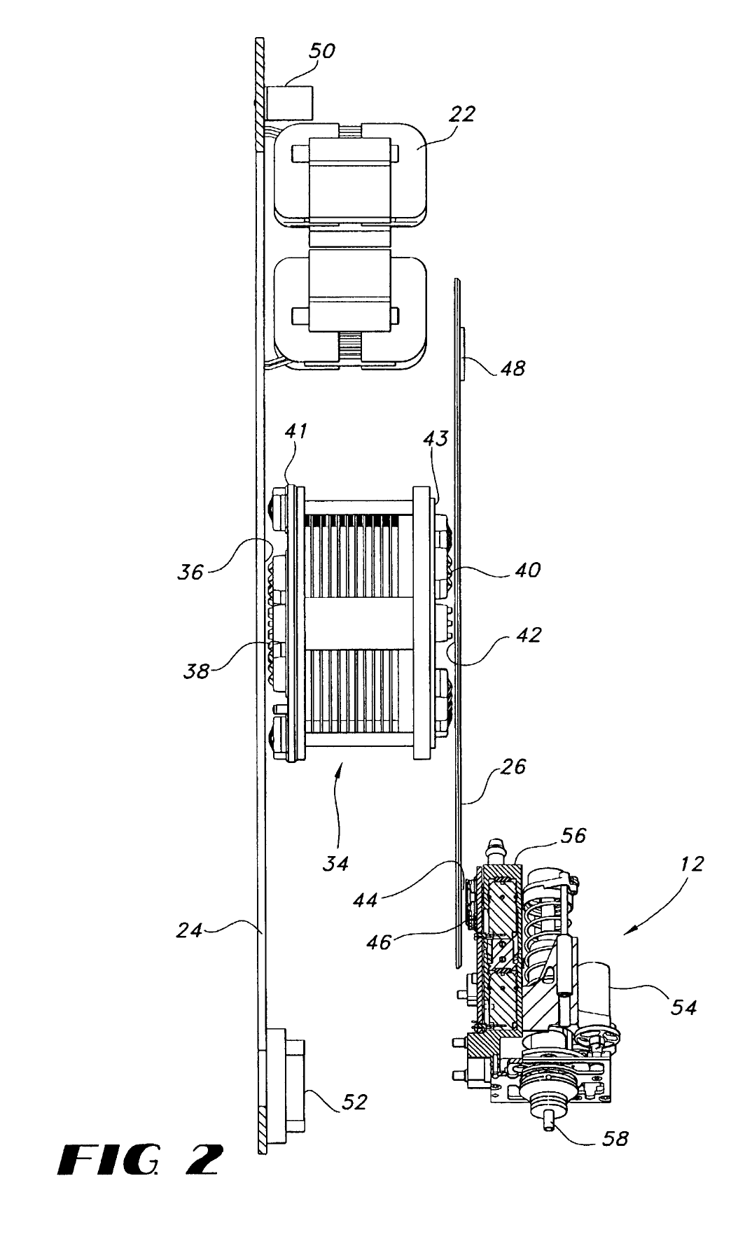

At a center section of the stationary circuit board 24 are located a plurality of contacts 36. See FIG. 2. The contacts 36 are preferably flat contact pads, and are connected to the bus connector 52 and the circuits on the stationary circuit board 24. However, alternative types of contacts, such as pins and sockets may be used instead of, or in addition to, the flat contact pads. As used herein, the term “electric contacts” includes the flat contact pads, as well as alternative types of contacts, such as the pins and sockets discussed above.

Mounted within a central hub 60 of the rear frame 16 of the pick and place head 10 is a slip ring assembly 34, which includes a plurality of contacts 38 facing the stationary circuit board 24, and which contacts 38 are connected to the contacts 36 on the stationary circuit board 24.

Mounted at a front side of the rotating spindle frame 20 is a rotating circuit board 26, which moves in unison with the rotating spindle frame 20. The rotating circuit board 26 includes a plurality of contacts 42 which are arranged to make electrical connection with a plurality of contacts 40 on the front face of the slip ring assembly 34. In a preferred embodiment of the present invention, the slip ring assembly is of the type manufactured by Poly scientific of Blacksburg, Va., which is a division of Northrup Grumman. However, other slip ring assemblies or connecting devices which are able to transfer a connection from a stationary circuit board to a moving or rotating circuit board, may be used in addition to that manufactured by Polyscientific.

A rear face 41 of the slip ring assembly 34 remains stationary so that the contacts 38 thereon engage with the contacts 36 of the stationary circuit board 24. However, a front face 43 of the slip ring assembly 34 is adapted to rotate with respect to the rear face 41 so that the contacts 40 on the front face 43 of the slip ring assembly 34 can maintain electrical engagement with the contacts 42 on the rotating circuit board 26. On the front face of the rotating circuit board 26 are located a plurality of contacts 44. Each of the spindle assemblies 12 includes a plurality of matching contacts 46, so that when the spindle assemblies 12 are mounted on the rotating spindle frame 20, the contacts 46 of the spindle assemblies 12 engage with the contacts 44 on the front face of the rotating circuit board 26.

In addition to providing an electrical connection between the contacts 40 of the slip ring assembly 34 to the contacts 46 of the spindle assemblies 12, the rotating circuit board 26 includes a plurality of processing circuits 48 incorporated therein. The processing circuits 48 relate to the control and operation of the spindle assemblies 12 and for communicating signals to and from the spindle assemblies through the CAN Bus protocol to the machine central control system.

For example, each of the spindle assemblies 12 includes a theta motor 54 for rotating the spindle 58 so as to correct the theta orientation of the spindle 58, if necessary. The theta motor may be a servo-motor, a stepper motor, or some other kind of motor known to be suitable for this application.

In addition, each of the spindle assemblies 12 includes two compressed air valves 56 for controlling the flow of air through the spindle 58 so that a vacuum or air pressure may be selectively applied to the spindle 58 for picking up or discharging components and/or dies.

Although only preferred embodiments are specifically illustrated and described herein, it will be appreciated that many modifications and variations of the present invention are possible in light of the above teachings and within the purview of the appended claims without departing from the spirit and intended scope of the invention.

What is claimed is:

1. A pick and place head for a pick and place machine, the pick and place head comprising:
a stationary frame;
a first circuit board mounted on the stationary frame, the first circuit board including a first plurality of circuits and a first plurality of electric contacts connected to the first plurality of circuits;
a rotating frame rotatably mounted to the stationary frame;
a plurality of spindle assemblies mounted on the rotating frame;
a second circuit board mounted on the rotating frame, the second circuit board including a second plurality of circuits relating to an operation of the plurality of spindle assemblies, and a second plurality of electric contacts connected to the second plurality of circuits;
a slip ring assembly mounted between the first circuit board and the second circuit board;
the slip ring assembly including a first portion having a third plurality of electric contacts and a second portion having a fourth plurality of electric contacts;
the first portion of the slip ring assembly being rotatable relative to the second portion of the slip ring assembly, and the slip ring assembly further including a set of electrical connectors that enable the third plurality of electric contacts to maintain electrical connection with the fourth plurality of electric contacts while the first portion rotates relative to the second portion;
the first portion being fixed relative to the first circuit board so that the third plurality of electric contacts are in electrical connection with the first plurality of electric contacts and the second portion being fixed relative to the second circuit board so that the fourth plurality of electric contacts are in electrical connection with the second plurality of electric contacts;
the second circuit board further including a fifth plurality of electric contacts, the fifth plurality of electric contacts engaged with respective contacts of the plurality of spindle assemblies;
a bus connector connected to the first plurality of circuits so as to provide power and control signals to the pick and place head; and
a motor to rotate the rotating frame.

2. The pick and place head of claim 1, further comprising an encoder on the rotating frame so that a position of the rotating frame can be monitored.

3. The pick and place head of claim 1, further comprising a spindle driving assembly mounted on the stationary frame, the spindle driving assembly including an actuating arm adapted to contact the spindle assembly in an actuating position.

4. The pick and place head of claim 1, further comprising a system for supplying pressurized air to the spindle assemblies.

5. The pick and place head of claim 1, wherein the second plurality of circuits includes processors for controlling the operation of the spindle assemblies.

6. The pick and place head of claim 1, wherein the fifth plurality of electric contacts include flat metal contact pads or pins and sockets.

7. The pick and place head of claim 1, wherein each of the spindle assemblies includes a motor for rotating a spindle in the spindle assembly to correct for theta orientation.

8. The pick and place head of claim 1, further comprising bearings mounted on the stationary frame for rotatably supporting the rotating frame.

9. A pick and place head for a pick and place machine, the pick and place head comprising:
a stationary frame;
a first circuit board mounted on the stationary frame, the first circuit board including a first plurality of electric circuits;
a rotating frame rotatably mounted to the stationary frame;
a plurality of spindle assemblies mounted on the rotating frame, each of the plurality of spindle assemblies including a set of electric contacts;
a second circuit board mounted on the rotating frame, the second circuit board including a second plurality of electric circuits;
a slip ring assembly mounted between the first circuit board and the second circuit board;
the slip ring assembly including a first portion and a second portion;
the first portion of the slip ring assembly being rotatable relative to the second portion of the slip ring assembly, and the slip ring assembly further including a set of electrical connectors that enable the first plurality of electric circuits to maintain electrical connection with the second plurality of electric circuits while the first portion rotates relative to the second portion;
the second circuit board further including a plurality of electric contacts, the plurality of electric contacts on the second circuit board engaged with respective ones of the contacts of the plurality of spindle assemblies;
a connector connected to the first plurality of circuits so as to provide power and control signals to the pick and place head; and
a motor to rotate the rotating frame.

10. The pick and place head of claim 9, further comprising an encoder on the rotating frame so that a position of the rotating frame can be monitored.

11. The pick and place head of claim 9 further comprising a spindle driving assembly mounted on the stationary frame, the spindle driving assembly including an actuating arm adapted to contact the spindle assembly in an actuating position.

12. The pick and place head of claim 9, further comprising a system for supplying pressurized air to the spindle assemblies.

13. The pick and place head of claim 9, wherein the second plurality of circuits includes processors for controlling the operation of the spindle assemblies.

14. The pick and place head of claim 9, wherein the plurality of electric contacts include flat metal contact pads.

15. The pick and place head of claim 9, wherein each of the spindle assemblies includes a motor for rotating a spindle in the spindle assembly to correct for theta orientation.

16. The pick and place head of claim 9, further comprising bearings mounted on the stationary frame for rotatably supporting the rotating frame.

17. The pick and place head of claim 9, wherein the connection is a bus connection.

18. A pick and place head for a pick and place machine, the pick and place head comprising:
a stationary frame;
a first circuit board mounted on the stationary frame, the first circuit board including a first plurality of electric circuits;
a rotating frame rotatably mounted to the stationary frame;
a plurality of spindle assemblies mounted one the rotating frame, each of the plurality of spindle assemblies including a set of electric contacts;
a second circuit board mounted on the rotating frame, the second circuit board including a second plurality of electric circuits;
cableless means arranged between the first circuit board and the second circuit board for providing an electric connection between the first plurality of circuits and the second plurality of circuits while the rotating frame rotates relative to the stationary frame;
the second circuit board further including a plurality of electric contacts, the plurality of electric contacts on the second circuit board engaged with respective ones of the contacts of the plurality of spindle assemblies;
a connector connected to the first plurality of circuits so as to provide power and control signals to the pick and place head; and
a motor to rotate the rotating frame.

19. The pick and place head of claim 18, further comprising an encoder on the rotating frame so that a position of the rotating frame can be monitored.

20. The pick and place head of claim 18, further comprising a spindle driving assembly mounted on the stationary frame, the spindle driving assembly including an actuating arm adapted to contact the spindle assembly in an actuating position.

21. The pick and place head of claim 18, further comprising a system for supplying pressurized air to the spindle assemblies.

22. The pick and place head of claim 18, wherein the second plurality of circuits includes processors for controlling the operation of the spindle assemblies.

23. The pick and place head of claim 18, wherein the plurality of electric contacts include flat metal contact pads.

24. The pick and place head of claim 18, wherein each of the spindle assemblies includes a motor for rotating a spindle in the spindle assembly to correct for theta orientation.

25. The pick and place head of claim 18, further comprising bearings mounted on the stationary frame for rotatably supporting the rotating frame.

26. The pick and place head of claim 18, wherein the connector is a bus connection.
